(19) United States
(12) Patent Application Publication
(10) Pub. No.: US 2007/0267259 A1
(43) Pub. Date: Nov. 22, 2007

(54) REAR SUSPENSION EYELET MOUNT SHOCK ASSEMBLY

(75) Inventors: Christopher K. Furman, Augusta, GA (US); Landon Ball, North Augusta, SC (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/419,290

(22) Filed: May 19, 2006

(51) Int. Cl. F16F 9/36

(52) U.S. Cl. 188/322.16

(57) ABSTRACT

A golf car shock absorber mount assembly includes a tubular sleeve connected to a shock absorber. A shock absorber mount bracket is fixed to a frame structure of the vehicle and engages a first end of the tubular sleeve. A bushing assembly within the tubular sleeve includes an elastomeric bushing having an outside cylindrical surface contacting a tubular sleeve inner cylindrical surface and an inner bore defining a cylindrical wall. A rigid tubular member includes a cylindrical body portion having a body outside surface and a washer portion positioned proximate to and extending radially outward with respect to the cylindrical body portion. The body outside surface and the cylindrical wall are bonded. The assembly permits a shock-absorber load and at least two non-load directional axes of motion between the tubular sleeve and the tubular member.

### FIELD

The present disclosure relates to devices and methods for using shock absorber assemblies, for example, in golf car and off-road utility vehicles.

### BACKGROUND

Golf cars and many off-road or utility vehicles commonly have rigid or single axle suspension systems for both the front steerable wheels and the rear driving wheels. Rear suspensions for these vehicles are most commonly leaf springs and/or coiled springs used to support the solid axle. One drawback is this design can provide a stiffer ride feel for the occupants and can also result in reduced control of the golf car over rough terrain and when turning at higher speeds. Some golf car designs have therefore utilized leaf spring and shock absorber combinations to both stabilize the vehicle and to provide a more comfortable ride. The leaf springs are used to promote side-to-side and bounce stability of the suspension. Shock absorbers dampen the leaf spring travel and frequency which therefore promote a more stable and comfortable ride feel.

Shock absorbers used in these applications are commonly connected to vehicle structure using a pedestal end mount having two side connections for installation. The pedestal end mount is effective, however its greater alignment complexity can often add to the time and costs associated with assembling and maintaining the suspension system. A less complex installation mount is therefore desirable for use in mounting shock absorbers in golf cars and/or off road utility vehicles.

### SUMMARY

A shock absorber mount assembly for a golf car provides first and second tubular sleeves, the first tubular sleeve connected to a cylinder end and the second tubular sleeve connected to a rod end of a shock absorber. The first tubular sleeve is connected to a frame member of the golf car. First and second bushing assemblies each slidably disposed within one of the first and second tubular sleeves include at least an elastomeric material bushing disposed within the tubular sleeve, and a tubular member. The tubular member includes a cylindrical body portion and a washer portion positioned proximate to and extending radially outward from a first end of the cylindrical body portion. The cylindrical body portion is disposed within a bore of the bushing. A bond integrally joins the tubular member to the bushing. The assembly permits a shock-absorber load and at least two non-load directional axes of motion between the tubular sleeve and the tubular member.

According to various embodiments, a shock absorber mount assembly for a golf car or off-road utility vehicle includes a tubular sleeve connected to one of a cylinder end and a rod end of a shock absorber. A shock absorber mount bracket is fixedly connected to a frame structure of the vehicle and adapted to engage a first end of the tubular sleeve. A bushing assembly slidably disposed within the tubular sleeve includes at least an elastomeric material bushing having an outside cylindrical surface positioned in contact with an inner cylindrical surface of the tubular sleeve, and an inner bore defining a cylindrical wall. A rigid tubular member includes a cylindrical body portion having a body outside surface and a washer portion positioned proximate to and extending radially outward from a first end of the cylindrical body portion. The body outside surface and the cylindrical wall of the bushing define a physically bonded connection.

According to still other various embodiments, a golf car can include a frame; an opposed pair of wheels rotatably connected to the frame; and a pair of shock absorber assemblies connected to the frame, each operable to move in response to a displacement of at least one of the wheels. Each shock absorber assembly includes first and second tubular sleeves each connected to one of a cylinder and a rod of a shock absorber. A first elastomeric material bushing having a central through bore is positioned within a bore of the first tubular sleeve. A second elastomeric material bushing having a central through bore is positioned within a bore of the second tubular sleeve. First and second rigid tubular members each including a cylindrical body portion are disposed within the central through bore of one of the first and second bushings. A washer portion is positioned proximate to and extends radially outward from a first end of the cylindrical body portion. Each cylindrical body portion and associated bushing define an integral bonded connection. The assemblies permit a shock-absorber load and at least two non-load directional axes of motion between each tubular sleeve and the corresponding tubular member.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a golf car having the rear suspension eyelet mount shocks according to various embodiments;

FIG. 2 is a bottom plan view of the golf car of FIG. 1;

FIG. 3 is a rear elevation view looking forward of the golf car of FIG. 1;

FIG. 4 is a partial perspective view of the components of a left rear suspension system identified in area 4 of FIG. 3, having the rear fender and body removed for clarity;

FIG. 5 is an elevation view of a fully extended shock absorber assembly of the present disclosure;

FIG. 6 is an elevation view of a fully retracted shock absorber assembly of the present disclosure;

FIG. 7 is a partial cross sectional front elevational view of the left rear suspension system of FIG. 4;

FIG. 8 is a cross sectional view taken at section 8-8 of FIG. 7;

FIG. 9 is a partial cross sectional, side elevational view taken at section 9 of FIG. 7;

FIG. 10 is a cross sectional view taken at section 10-10 of FIG. 9; and

FIG. 11 is a top plan view of the left rear suspension system of FIG. 4.

### DESCRIPTION OF VARIOUS EMBODIMENTS

The following description is merely exemplary in nature and is in no way intended to limit the present disclosure, their application, or uses. Throughout this specification, like reference numerals will be used to refer to like elements. As referred to herein, the term “golf car” is synonymously used to describe application of the present disclosure to golf cars as well as sport utility vehicles such as modified golf cars, used for example as food and/or beverage cars, golf cars adapted for use as hunting/sporting clays vehicles, golf course maintenance vehicles, and the like.

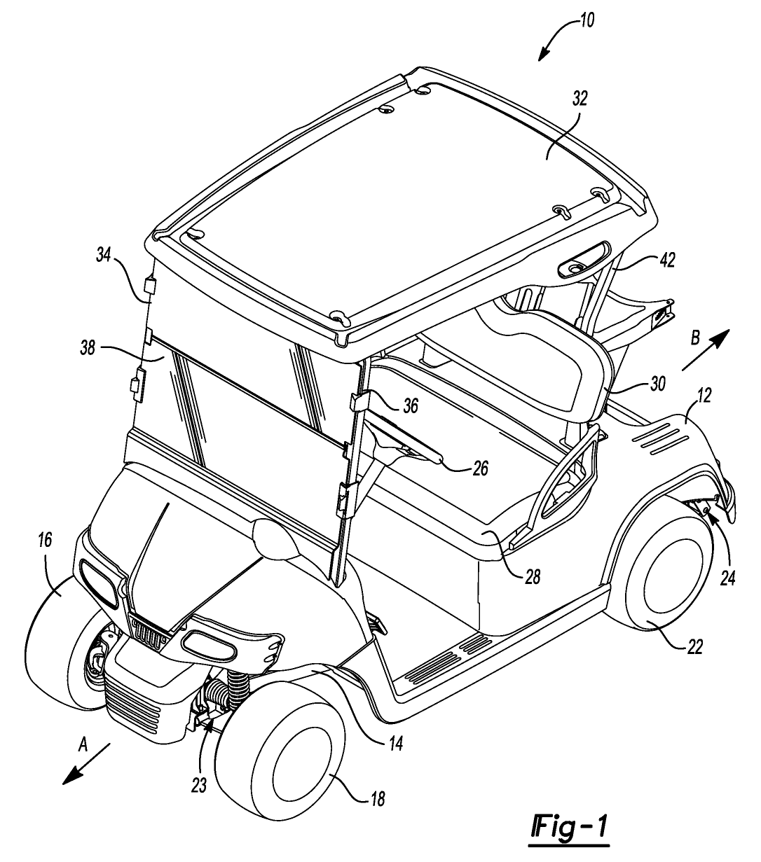

Referring generally to FIG. 1, a golf car 10 can include a body 12 supported from a structural frame 14. Frame 14 can also support a plurality of wheels including a first steerable 16 and a second steerable wheel 18. In addition, powered or driven wheels including a first driven wheel 20 and a second driven wheel 22 are commonly connected to a rear structural portion of frame 14. A front suspension system 23 can also be provided which is adapted for supporting each of the first and second steerable wheels 16, 18. A rear suspension system 24 can also be provided which is adapted for supporting each of the first and second driven wheels 20, 22. A steering mechanism 26 which commonly includes a steering wheel and a support post assembly is also included to provide the necessary steering input to first and second steerable wheels 16, 18.

Golf car 10 can also include a passenger bench seat 28 and a passenger back support cushion 30. A cover or roof 32 can also be provided which is supported from either body 12 or frame 14 by first and second support members 34, 36. A windscreen or windshield 38 can also provided which is also supported by each of first and second support members 34, 36. A rear section of roof 32 can be supported by each of a first and a second rear support frame element 40, 42. Other items provided with golf car 10 include golf bag support equipment, accessory racks or bins, headlights, side rails, fenders, and the like.

Golf car 10 is commonly propelled by a power unit such as an engine or battery/motor system which is commonly provided below and/or behind bench seat 28. Golf car 10 is capable of motion in either of a forward direction “A” or a rearward direction “B”. Each of first and second steerable wheels 16, 18 can be simultaneously turned using steering mechanism 26. Each of first and second steerable wheels 16, 18 can be independently supported to frame 14 using front suspension system 23. This permits each of first and second steerable wheels 16, 18 to deflect upwardly or downwardly as viewed in FIG. 1 independent of each other. Each of first and second steerable wheels 16, 18 can also be rigidly or collectively supported to frame 14, therefore the present disclosure are not limited by the design of front suspension system 23.

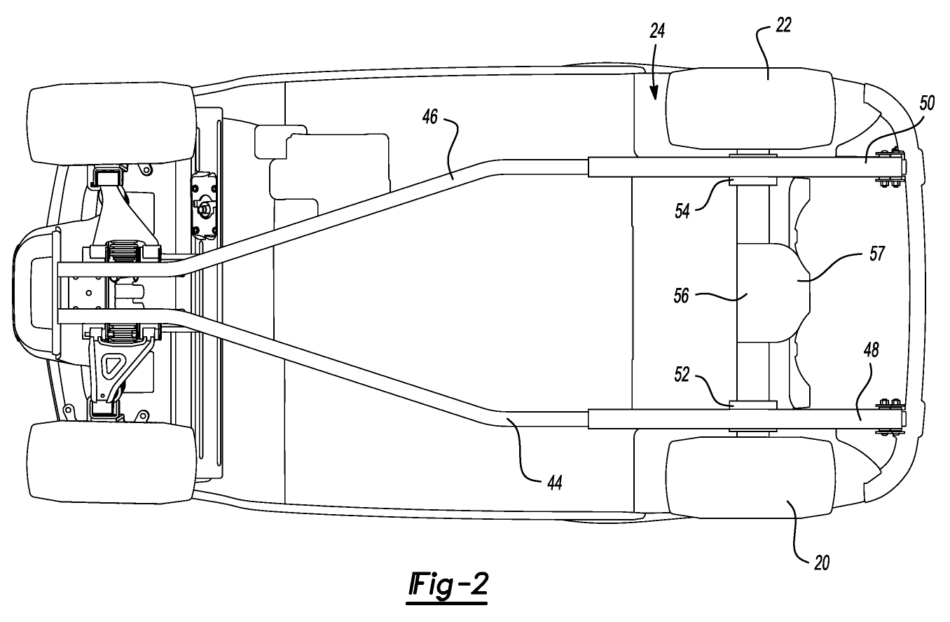

As best seen in reference to FIG. 2, frame 14 can further include a longitudinally arranged first frame member 44 and a second frame member 46. First and second frame members 44, 46 can be hollow, tubular shaped members which are created of a steel material or similar structural material and formed by welding, extruding, hydroforming, or similar process(es). A first and second leaf spring assembly 48, 50 support each of first and second driven wheels 20, 22. A first eyelet mount shock assembly 52 can be connected to a first leaf spring assembly 48 and first frame member 44. Similarly, a second eyelet mount shock assembly 54 can be connected to a second leaf spring assembly 50 and second frame member 46. Each of first and second eyelet mount shock assemblies 52, 54 are also connected to an axle housing 56 within which an axle (not shown) is rotatably disposed for providing driving power to the first and second driven wheels 20, 22 through a gear train or axle gear housing 57 connected to the power unit.

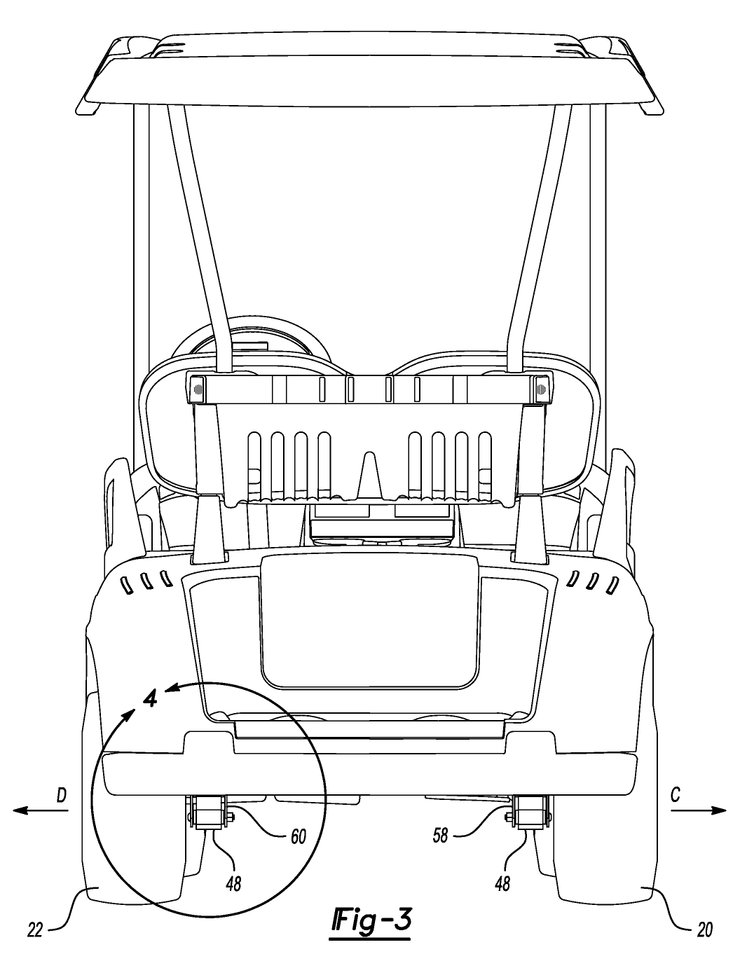

Referring now to FIG. 3, a first bracket assembly 58 connects a rear portion of first leaf spring assembly 48 to frame 14. Similarly, a second bracket assembly 60 connects a rear portion of second leaf spring assembly 50 to frame 14. First and second leaf spring assemblies 48, 50 and first and second bracket assemblies 58, 60 reduce side-to-side deflection of first and second driven wheels 20, 22 in deflection directions “C” and “D” while permitting vertical deflection of these wheels.

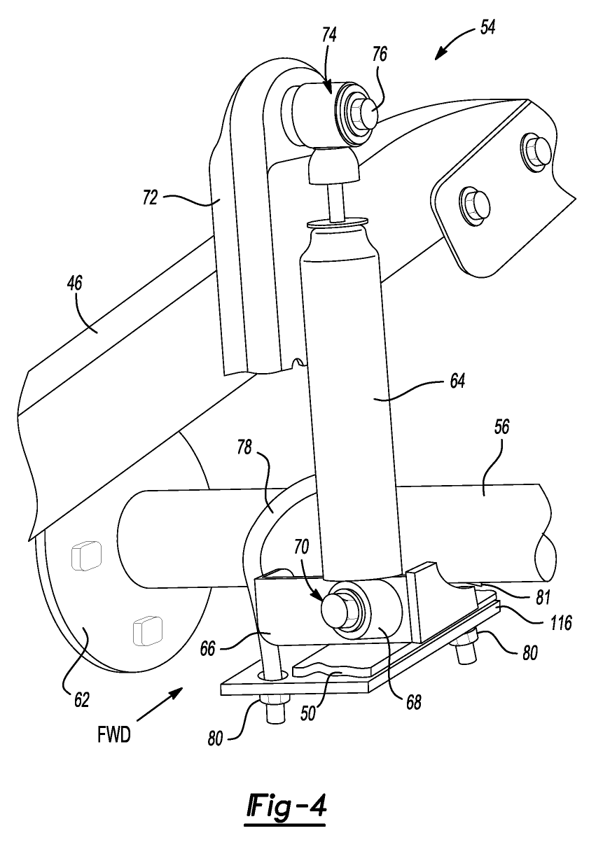

Referring now to FIG. 4, further details of the second eyelet mount shock assembly 54 are provided. Details of the first eyelet mount shock assembly 52 are similar to or a mirror image configuration of second eyelet mount shock assembly 54 and are therefore not further discussed in detail herein. Second eyelet mount shock assembly 54 is positioned proximate to a wheel hub 62 which is rotatably disposed at a distal end of axle housing 56 and is used to rotatably mount second driven wheel 22. A shock absorber assembly 64 is connected at a first end to a mount bracket 66 using a first tubular sleeve 68 of the shock absorber assembly 64. A first fastener 70 is inserted through first tubular sleeve 68 to engage first tubular sleeve 68 to mount bracket 66. In various embodiments, a second end of shock absorber assembly 64 is connected to a shock absorber mount bracket 72 using a second tubular sleeve 74 and a second fastener 76. Shock absorber mount bracket 72 is not required and can be eliminated if first and second frame members 44, 46 are spaced sufficiently from axle housing 56 so second tubular sleeve 74 can be directly connected to first or second frame member 44, 46 and allow a complete displacement of shock absorber assembly 64.

As also shown in FIG. 4, a U-bolt 78 can be positioned about axle housing 56 and disposed through apertures of second leaf spring assembly 50 and fixed to second leaf spring assembly 50 using a plurality of nuts 80. Second leaf spring assembly 50 is therefore fixedly connected to mount bracket 66 to prevent or limit displacement between mount bracket 66 and second leaf spring assembly 50. Mount bracket 66 is in turn fixedly connected to axle housing 56 using a connection joint 81 which in various embodiments is a weld joint. Shock absorber assembly 64 and second leaf spring assembly 50 are therefore fixedly connected to axle housing 56 allowing the spring deflection of second leaf spring assembly 50 to be dampened by shock absorber assembly 64. Shock absorber mount bracket 72 can be fixedly connected to second frame member 46 for example using a weld joint, one or more fasteners, or additional clamping elements. Shock absorber mount bracket 72 can also be eliminated if sufficient distance between axle housing 56 and second frame member 46 are provided.

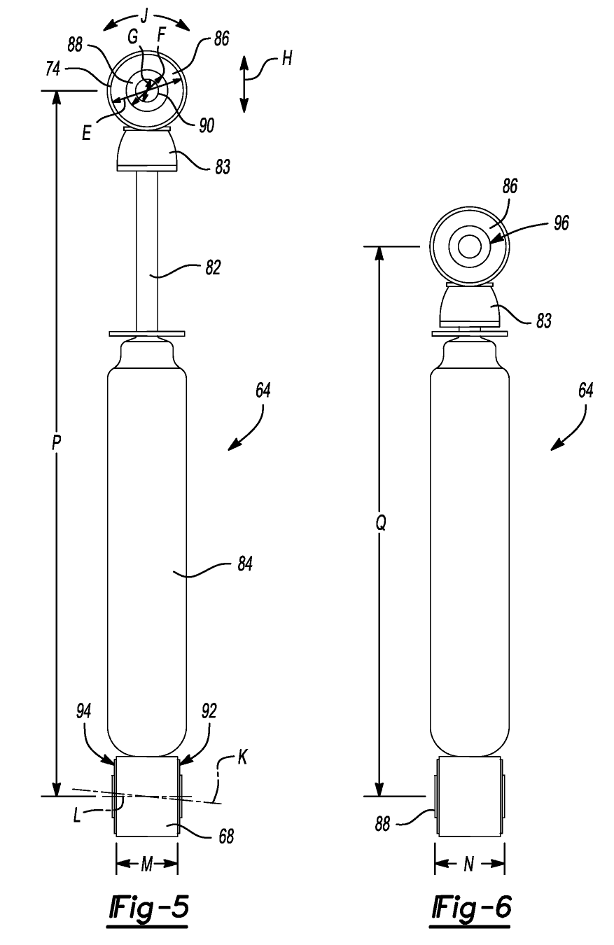

Referring now generally to FIGS. 5 and 6, shock absorber assembly 64 includes a piston rod 82 which is slidably disposed within a cylinder 84. A resilient material jounce bumper 83 is positioned between second tubular sleeve 74 and piston rod 82 to provide a shock cushion or “soft limiting” member. A piston (not shown) is positioned at a distal end of piston rod 82 and within cylinder 84 as commonly known. A bushing assembly includes a bushing 86 and a tubular member 88 disposed within each of the first and second tubular sleeves 68, 74. Bushing 86 is provided from a resilient material such as rubber or similar elastomeric material or compound. An outside diameter of bushing 86 contacts a sleeve inner diameter “E” of either first or second tubular sleeve 68, 74. First tubular sleeve 68 is fixedly connected to a cylinder end of cylinder 84 and second tubular sleeve 74 is fixedly connected to a rod end of piston rod 82. Tubular member 88 is disposed within a receiving aperture of bushing 86. Tubular member 88 can be provided from a rigid material such as metal including steel, brass, or the like. A fastener through aperture 90 is provided within each tubular member 88 to receive a fastener such as first fastener 70 or second fastener 76. A tubular member outer diameter “F” defines and outer surface which engages the material at the wall defined by a through bore inner diameter of bushing 86. Fastener through aperture 90 includes a fastener diameter “G” which is larger than the fastener inserted there-through. Each of the connections between first or second tubular sleeves 68, 74 through either mount bracket 66 or shock absorber mount bracket 72 allow at least three axes of movement for shock absorber assembly 64. These three axes include a load bearing axis “H” substantially parallel to a longitudinal axis of piston rod 82, and two non-load axes, including a rotational axis or rotational angle “J” defined relative to a longitudinal axis “L” of either first or second fastener 70 or 76, and a twist axis “K”. First fastener 70 and second fastener 76 each define fastener axis “L” through either first or second tubular sleeve 68, 74. Twist axis “K” is measurable as an angular displacement of fastener axis “L” with respect to either first or second tubular sleeve 68, 74.

Each of first and second tubular sleeves 68, 74 have a tubular sleeve length “M”. Each tubular member 88 includes a tubular member length “N” which is either equal to or greater than the tubular sleeve length “M” to prevent longitudinal compression of bushing 86. When piston rod 82 is fully extended from cylinder 84, shock absorber assembly 64 has an extended length “P”. Similarly, when piston rod 82 is fully received within cylinder 84, shock absorber assembly 64 has a compressed length “Q”. The differences between extended length “P” and compressed length “Q” provide a maximum possible displacement of either first or second leaf spring assembly 48 or 50. Tubular sleeve length “M” is measurable between each of a first end 92 and a second end 94 of either first tubular sleeve 68 or second tubular sleeve 74. In several embodiments, and as shown in FIG. 6, tubular member 88 is longer than the tubular sleeve length “M” and a portion of tubular member 88 extends beyond each of first and second ends 92, 94. Also, in several embodiments, bushing 86 is bonded to tubular member 88 to create a bonded connection 96. For example, bonded connection 96 can be a vulcanized connection between the softer resilient material of bushing 86 and the metal material of tubular member 88. Bonded connection 96 prevents free rotation of bushing 86 within first or second tubular sleeves 68, 74 when opposite ends of tubular member 88 are engaged to either mount bracket 66 or shock absorber mount bracket 72 by first or second fastener 70, 76.

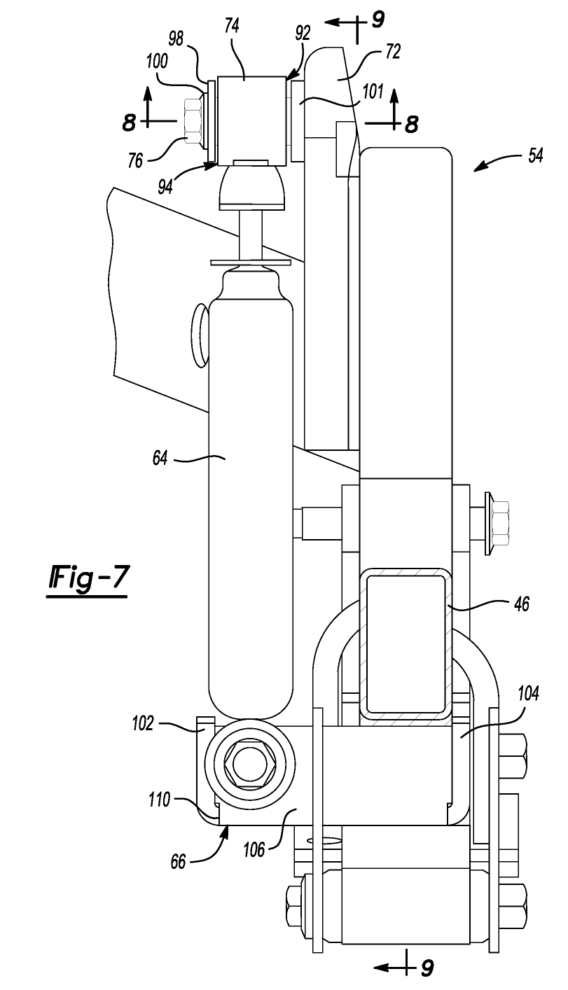

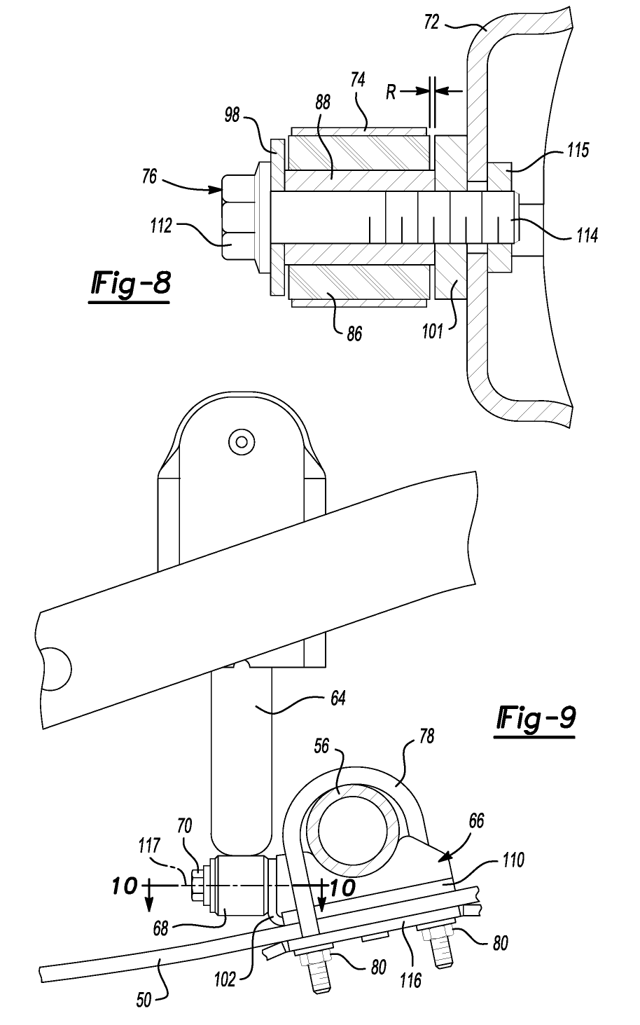

As best seen in reference to FIGS. 7 and 8, a first washer 98 is positioned at a first end of each tubular member 88 either by engagement with second fastener 76 or by fixedly connecting first washer 98 such as by welding to the first end of tubular member 88. First washer 98 extends radially outward with respect to the corresponding tubular member 88. When second fastener 76 is disposed through second tubular sleeve 74, a first fastener end or an engagement portion 100 of second fastener 76 contacts first washer 98 and first washer 98 in turn directs the load from second fastener 76 through tubular member 88 to shock absorber mount bracket 72. In some embodiments, a second washer 101 is positioned between first end 92 of second tubular sleeve 74 and shock absorber mount bracket 72 and welded to bracket 72, defining a seat for engagement by second tubular sleeve 74. Second washer 101 performs a similar function to first washer 98 in distributing the fastener and shock absorber tubular sleeve loads to shock absorber mount bracket 72, allowing the thickness and therefore the weight of shock absorber mount bracket 72 to be optimized. By varying a thickness of second washer 101, second washer 101 can also be used to permit adjustment to the spacing between second tubular sleeve 74 and shock absorber mount bracket 72 to accommodate vehicle-to-vehicle dimensional differences. To permit rotation and load deflection between first or second tubular sleeves 68, 74 relative to first and second fasteners 70, 76, a diameter of first washer 98 is controlled to prevent contact between first washer 98 and first or second tubular sleeves 68, 74.

Mount bracket 66 in some embodiments is created from a portion of plate material having bends defining side walls. These include each of a first and second bracket side 102, 104 and each of a first and second bracket end 106, 108. Second bracket end 108 is not visible in FIG. 7. Each of first and second bracket sides 102, 104 and first and second bracket ends 106, 108 are integrally connected to a bracket base 110.

Referring now more specifically to FIG. 8, in an installed condition and after torquing second fastener 76, an assembly of second tubular sleeve 74 provides a fixed, substantially non-rotatable connection between a first fastener end of second fastener 76 defined as a hex head 112, first washer 98, tubular member 88, second washer 101, and shock absorber mount bracket 72. Bonded connection 96 is created between an outer wall 97 of tubular member 88 and an inner wall 99 of bushing 86 when tubular member 88 is received in a central through aperture created in bushing 86. The connection created between an outer surface 109 of bushing 86 and an inner surface 111 of second tubular sleeve 74, created when bushing 86 is received in a through bore of second tubular sleeve 74, is not bonded, and according to various embodiments can be a frictional connection or a sliding/rotating connection.

In various embodiments, a fastener through aperture 113 created through shock absorber mount bracket 72 receives a threaded shank 114 of second fastener 76. A second fastener end of second fastener 76, defined at a distal end of shank 114 is threadably engaged with a first fixed nut 115 oppositely disposed about shock absorber mount bracket 72 from tubular member 88. First fixed nut 115 can be non-rotatably fixed to shock absorber mount bracket 72 for example by a tack weld, a bent tab, an adhesive connection, or the like, or first fixed nut 115 can be temporarily held during torquing of second fastener 76. Second fastener 76 is engaged with first fixed nut 115 providing fixed contact for the metal components of the assembly while permitting a clearance dimension “R” between either or both bushing 86 and second tubular sleeve 74, and each of first washer 98 and second washer 101. By allowing for clearance dimension “R”, longitudinal compression of bushing 86 is prevented while allowing rotational displacement between second tubular sleeve 74 and second washer 101 as rotational axis angle “J”, as well as the twist previously defined as displacement along twist axis angle “K”. A transverse displacement of second tubular sleeve 74 with respect to second fastener 76 can also result in compression of bushing 86 along load bearing axis “H”.

Referring now generally to FIG. 9, a fixed relationship between second leaf spring assembly 50, mount bracket 66 and first tubular sleeve 68 is provided by tightening nuts 80 on U-bolt 78. Axle housing 56 is thereby fixedly connected to mount bracket 66. At the same time, second leaf spring assembly 50 is also fixedly engaged between bracket base 110 of mount bracket 66 and a bracket plate 116. First fastener 70 is then inserted and engaged at first bracket side 102 along a second fastener longitudinal axis 117.

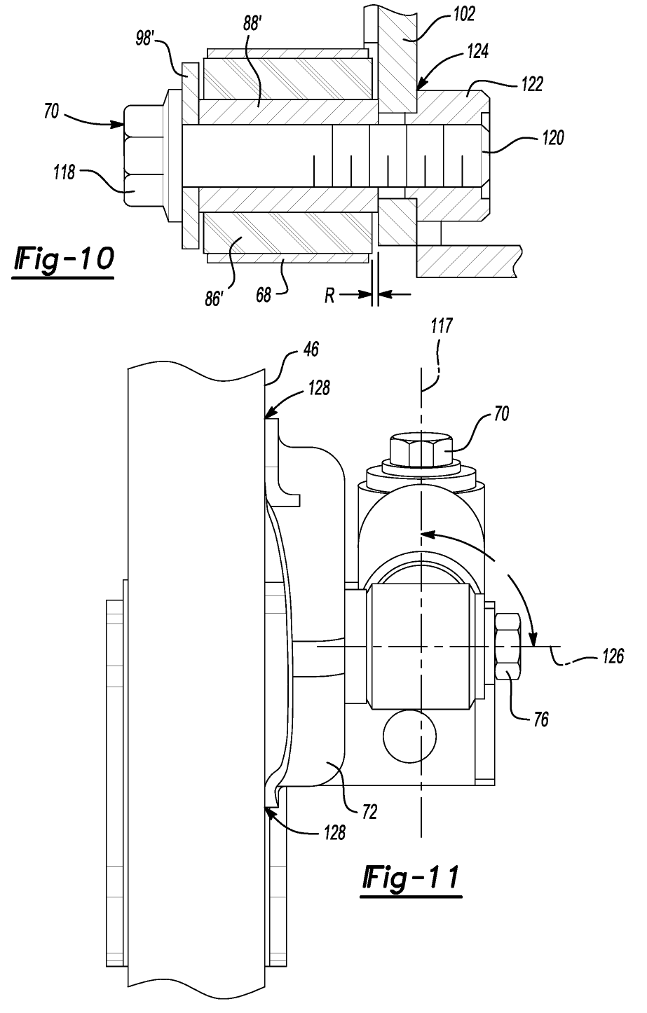

Referring now generally to FIG. 10, an assembly of first tubular sleeve 68 is similar to the assembly of second tubular sleeve 74. The assembly includes first fastener 70 having a hex head 118 at a first fastener end which engages with a first washer 98′ which is fixedly connected to a tubular member 88′ which in turn contacts first bracket side 102 of mount bracket 66. Bushing 86′ is disposed between tubular member 88′ and first tubular sleeve 68. A threaded shank 120 of first fastener 70 defining a second fastener end of first fastener 70 extends beyond first bracket side 102 to threadably engage within a second fixed nut 122. Similar to first fixed nut 115, second fixed nut 122 can also be fixedly connected to first bracket side 102 using for example a tack weld, a bent tab, or an adhesive connection, or temporarily held in place during torquing of first fastener 70. Similar to the installation of second fastener 76, when torquing first fastener 70, hex head 118 contacts first washer 98′ and forces tubular member 88′ into contact with first bracket side 102. Clearance dimension “R” is also provided for this assembly between bushing 86′ and either first washer 98′ and/or first bracket side 102.

Referring now to FIG. 11, a second fastener longitudinal axis 126 defined through second fastener 76 is oriented with respect to first fastener longitudinal axis 117 by an angle α. In several embodiments, angle α is substantially equal to 90°, but can vary in other embodiments depending on the configuration of the rear suspension system 24. Connection joints 128 such as weld joints are also visible in this view connecting shock absorber mount bracket 72 to second frame member 46.

Rear suspension pilot mount shock assemblies of the present disclosure offer several advantages. By bonding a resilient bushing to a tubular member and positioning the tubular member within a tubular sleeve of a shock absorber assembly, normal compression loading of the bushing as well as two additional axes of motion are provided for motion of the shock absorber assembly in a suspension system of a golf car. The bonded connection also helps ensure proper alignment and clearance dimensions are provided to prevent binding of the bushing when a single element fastener is used to connect either end of the shock absorber assembly to structure of the golf car. By fixing a receiving nut with a bracket of the present disclosure or a structural member of the golf car, the single element fasteners used to connect both tubular members of the shock absorber assembly are pre-aligned for easier installation. Further, the flange fixedly connected to a tubular member of the present disclosure helps to distribute the load between the fastener and the golf car structure.

The description herein is merely exemplary in nature and, thus, variations that do not depart from the gist of that which is described are intended to be within the scope of the present disclosure. Such variations are not to be regarded as a departure from the spirit and scope of the present disclosure.

What is claimed is:

1. A shock absorber mount assembly for a golf car, comprising:
first and second tubular sleeves, the first tubular sleeve connected to a cylinder and the second tubular sleeve connected to a rod of a shock absorber, the first tubular sleeve further connected to a frame member of the golf car; and
first and second bushing assemblies each slidably disposed within one of the first and second tubular sleeves, each bushing assembly at least including:
an elastomeric material bushing disposed within the tubular sleeve; and
a tubular member including a cylindrical body portion and a washer portion positioned proximate to and extending radially outward with respect to a first end of the cylindrical body portion, the cylindrical body portion disposed within a bore of the bushing, a bonded connection integrally joining the cylindrical body portion to the bushing, the assembly operable to permit a shock absorber load and at least two non-load directional axes of motion between the tubular sleeve and the tubular member.

2. The shock absorber mount assembly of claim 1, wherein each tubular sleeve comprises both a first end and a second end, the second end contacting the frame member of the golf car in an assembled state of the mount assembly.

3. The shock absorber mount assembly of claim 2, further comprising:
a fastener through aperture created through the tubular member; and
a fastener inserted in the fastener through aperture and engageable at a first fastener end with the washer portion.

4. The shock absorber mount assembly of claim 3, further comprising:
a fastener clearance aperture created in the frame member of the golf car; and
a threaded nut fixedly connected to the frame member and operable to threadably receive a second fastener end of the fastener inserted through both the fastener through aperture and the fastener clearance aperture.

5. The shock absorber mount assembly of claim 4, comprising a non-rotatable connection of both the washer portion with the first end of the tubular sleeve and the second end of the tubular sleeve to the frame member of the golf car is created by an engagement torque applied to the fastener.

6. The shock absorber mount assembly of claim 1, wherein each tubular member and each tubular sleeve comprises a metal material.

7. The shock absorber mount assembly of claim 1, further comprising a washer defining a tubular sleeve seat positioned between the second end of the tubular sleeve and the frame member and fixedly connected to the frame member.

8. The shock absorber mount assembly of claim 1, wherein the integral bond comprises a vulcanized bond.

9. The shock absorber mount assembly of claim 1, wherein the at least two axes of motion include:
a first axis of motion defining an axial rotation angle; and
a second axis of motion defining a longitudinal displacement angle.

10. The shock absorber mount assembly of claim 1, wherein a length of the cylindrical body portion is one of substantially equal to and greater than a bushing length to operably prevent longitudinal compression of the bushing.

11. The shock absorber mount assembly of claim 1, wherein both the first and second sleeves define a diameter greater than a diameter of the washer portion.

12. The shock absorber mount assembly of claim 1, wherein the bonded connection further comprises:
an inner wall of the bushing defined by a central inner bore; and
a body outside surface of the cylindrical body portion, the bonded connection located between the body outside surface and the inner wall of the bushing.

13. The shock absorber mount assembly of claim 1, further comprising a cylindrical outside surface of the bushing positioned in contact with a cylindrical inner surface of the tubular sleeve.

14. A shock absorber mount assembly for a golf car, comprising:
a tubular sleeve connected to one of a cylinder and a rod of a shock absorber assembly;
a shock absorber mount bracket fixedly connected to a frame structure of the vehicle and operable to engage a first end of the tubular sleeve; and
a bushing assembly slidably disposed within the tubular sleeve, the bushing assembly at least including:
an elastomeric material bushing postioned at least within a bore of the tubular sleeve, the bushing having a central through bore; and
a rigid tubular member including a cylindrical body portion disposed within the through bore of the bushing and a washer portion postioned proximate to and extending radially outward with respect to a first end of the cylindrical body portion, the cylindrical body portion and the bushing defining a physically bonded connection, the assembly operable to permit a shock absorber load and at least two non-load directional axes of motion between the tubular sleeve and the tubular member.

15. The mount assembly of claim 14, wherein the shock absorber mount bracket further comprises:
first and second opposed bracket sides;
first and second opposed bracket ends, each bracket end oriented substantially transverse to the bracket sides; and
a bracket base having the bracket sides and the bracket ends integrally extending from the bracket base.

16. The mount assembly of claim 15, further comprising a fastener engageable with the washer portion and insertable through a through aperture of the cylindrical body portion to engage the frame structure.

17. The mount assembly of claim 16, further comprising:
a first diameter of the washer portion; and
a second diameter of the tubular sleeve;
wherein the first diameter is one of equal to and greater than the second diameter to operably prevent removal of the shock absorber tubular sleeve over the fastener and provide a spacing for the bushing to prevent contact between the washer portion and the tubular sleeve upon deflection of the bushing.

18. The mount assembly of claim 17, wherein the first end of the tubular sleeve is engageable with the first bracket side using the fastener inserted through the through aperture of the cylindrical body portion.

19. The mount assembly of claim 14, wherein the integral bond comprises a vulcanized bond.

20. The mount assembly of claim 14, wherein the at least two axes of motion include:
a first axis of motion defining an axial rotation angle; and
a second axis of motion defining a longitudinal displacement angle.

21. The mount assembly of claim 14, wherein a length of the cylindrical body portion is one of substantially equal to and greater than a bushing length.

22. A golf car, comprising:
a frame;
an opposed pair of wheels rotatably connected to the frame; and
a pair of shock absorber assemblies connected to the frame, each operable to move in response to a displacement of at least one of the wheels, each shock absorber assembly including:
first and second tubular sleeves each connected to one of a cylinder and a rod of a shock absorber;
a first elastomeric material bushing having a central through bore, the first bushing positioned within a bore of the first tubular sleeve;
a second elastomeric material bushing having a central through bore, the second bushing positioned within a bore of the second tubular sleeve; and
first and second rigid tubular members each including a cylindrical body portion disposed within the central through bore of one of the first and second bushings and a washer portion positioned proximate to and extending radially outward with respect to a first end of the cylindrical body portion, each cylindrical body portion and associated bushing defining an integral bonded connection, the assemblies operable to permit a shock absorber load and at least two non-load directional axes of motion between each tubular sleeve and the corresponding tubular member.

23. The golf car of claim 22, further comprising a mount bracket engaged with a first end of the first tubular sleeve of each shock absorber assembly.

24. The golf car of claim 23, further comprising a axle housing disposed between the pair of wheels, the axle housing fixedly engaged to the mount bracket of each shock absorber assembly.

25. The golf car of claim 24, further comprising a U-shaped bolt operable to fixedly engage the axle housing to the mount bracket of each shock absorber assembly.

26. The golf car of claim 25, further comprising a leaf spring assembly fixedly connected to each mount bracket using the U-shaped bolt.

27. The golf car of claim 22, further comprising a shock absorber mount bracket engaged with a first end of the second tubular sleeve of each shock absorber assembly.

28. The golf car of claim 27, further comprising at least one weld joint fixedly connecting the shock absorber mount bracket to the frame.

29. The golf car of claim 27, further comprising a spacer element positioned between the shock absorber mount bracket and the first end of the second tubular sleeve of each shock absorber assembly.

30. The golf car of claim 22, wherein the at least two axes of motion include:
a first axis of motion defining an axial rotation angle;
a second axis of motion defining a longitudinal displacement angle; and
a third axis of motion defining a load bearding axis substantially parallel to the rod.

31. The golf car of claim 22, wherein a length of the cylindrical body portion is one of substantially equal to and greater than a bushing length.

32. The golf car of claim 22, wherein each tubular sleeve comprises a sleeve diameter one of less than and equal to a diameter of the washer portion.

33. The golf car of claim 22, wherein each of the shock absorber assemblies comprises a jounce bumper positioned between a piston rod and the second tubular sleeve.
